(19) United States
(12) Patent Application Publication
(10) Pub. No.: US 2018/0090110 A1
(43) Pub. Date: Mar. 29, 2018

(54) APPARATUS AND METHOD FOR VIDEO FRAME ROTATION

(71) Applicant: Faraday Technology Corp., Hsinchu (TW)

(72) Inventors: Cheng-Yen Huang, Hsinchu City (TW); Chun-Yuan Lai, Hsinchu City (TW)

(73) Assignee: Faraday Technology Corp., Hsinchu (TW)

(21) Appl. No.: 15/350,117

(22) Filed: Nov. 14, 2016

(30) Foreign Application Priority Data
Sep. 26, 2016 (TW) 105130971

(51) Int. Cl. G09G 5/393; H04N 5/907

(52) U.S. Cl. CPC G09G 5/393; H04N 5/907

(57) ABSTRACT

An apparatus and a method for video frame rotation are provided. The apparatus includes a synchronous dynamic random access memory (SDRAM) and a video rotation circuit. The video rotation circuit is coupled to the SDRAM. The video rotation circuit sequentially writes a plurality of pixels of a video frame into the SDRAM in a row-by-row scanning manner. The video rotation circuit divides a plurality of columns of the video frame into a plurality of column sets, so as to divide each of the rows of the video frame into a plurality of sub-rows. The video rotation circuit performs an internal column-set scanning for each of the column sets in a column-set-by-column-set manner, so as to discretely read the sub-rows from the SDRAM.

### CROSS-REFERENCE TO RELATED APPLICATION

This application claims the priority benefit of Taiwan application serial no. 105130971, filed on Sep. 26, 2016. The entirety of the above-mentioned patent application is hereby incorporated by reference herein and made a part of this specification.

### BACKGROUND OF THE INVENTION

### Field of the Invention

The invention relates to a video apparatus, and particularly relates to an apparatus and a method for video frame rotation.

### Description of Related Art

A synchronous dynamic random access memory (SDRAM) has a data burst characteristic. FIG. 1 is a schematic diagram of data burst transmission of the SDRAM. In FIG. 1, a horizontal axis represents time, and before each data burst, the SDRAM requires to spend a period of time 110, which is referred to as a latency penalty. The latency penalty 110 is probably as long as several or a dozen clock cycles, for example, 4 clock cycles. After the latency penalty 110 is ended, a data pin of the SDRAM may transmit (input or output) a plurality of valid data of continuous addresses to complete one data burst. Before a next data burst, the SDRAM requires to again spend a latency penalty 120. The SDRAM is the conventional technique, and detail thereof is not repeated.

The SDRAM may serve as a frame memory of a video frame rotation apparatus, which is used for storing complete video frames. FIG. 2 is a schematic diagram of rotation of a video frame 210. The video frame 210 shown in FIG. 2 is a 3*9 video frame. The video frame 210 includes pixels P[1,1]-P[1,9], P[2,1]-P[2,9] and P[3,1]-P[3,9], as shown in FIG. 2. It is assumed that the video frame 210 is required to be rotated into a 9*3 video frame, so as to display the rotated video frame on a portrait mode display panel 220. The video frame 210 can be stored in the SDRAM (the frame memory). The pixels P[1,1]-P[3,9] of the video frame 210 shown in FIG. 2 are stored in continuous addresses M1-M27, for example, the pixel P[1,1] is stored in the address M1, the pixel P[1,2] is stored in the address M2, and the others are deduced by analogy, and the pixel P[3,9] is stored in the address M27. Any one of the addresses M1-M27 shown in FIG. 2, for example, the address M1 may represent a single address of the SDARAM, and may also represent a set of addresses (a plurality of continuous addresses) of the SDRAM.

FIG. 3 is a schematic diagram of data burst transmission of the SDRAM when video frame rotation is performed. In FIG. 3, a horizontal axis represents time. When the video frame 210 is about to be rotated into the 9*3 video frame, a conventional video frame rotation apparatus may read corresponding pixels from the SDRAM according to a scanning sequence of the portrait mode display panel 220. For example, the conventional video frame rotation apparatus reads the pixel P[3,1] to the portrait mode display panel 220 from the address M19 of the SDRAM, and then reads the pixel P[2,1] to the portrait mode display panel 220 from the address M10 of the SDRAM, and reads the pixel P[1,1] to the portrait mode display panel 220 from the address M1 of the SDRAM. However, since the addresses M19, M10 and M1 are discrete, each time before a single pixel data is transmitted, the SDRAM requires to spend a latency penalty. For example, as shown in FIG. 3, after a latency penalty 310 is ended, the data pin of the SDRAM may transmit the output pixel P[3,1] to the portrait mode display panel 220. Before the data pin of the SDRAM outputs the pixel P[2,1] to the portrait mode display panel 220, the SDRAM requires to again spend a latency penalty 320. Before the data pin of the SDRAM outputs the pixel P[1,1] to the portrait mode display panel 220, the SDRAM requires to again spend a latency penalty 330, and transmission of other pixels can be deduced by analogy.

Apparently, during a process of the video frame rotation, the conventional video frame rotation apparatus requires to spend a large amount of the latency penalties.

### SUMMARY OF THE INVENTION

The invention is directed to an apparatus and a method for video frame rotation, by which a latency penalty of a synchronous dynamic random access memory (SDRAM) is decreased.

An embodiment of the invention provides a video frame rotation apparatus. The video frame rotation apparatus includes a synchronous dynamic random access memory (SDRAM) and a video rotation circuit. The video rotation circuit is coupled to the SDRAM. The video rotation circuit sequentially writes a plurality of pixels (pixel data) of a video frame into the SDRAM in a row-by-row scanning manner. The video rotation circuit divides a plurality of columns of the video frame into a plurality of column sets, so as to divide each of rows of the video frame into a plurality of sub-rows. The video rotation circuit performs an internal column-set scanning for each of the column sets in a column-set-by-column-set manner, so as to discretely read the sub-rows from the SDRAM.

An embodiment of the invention provides a method for video frame rotation. The method for video frame rotation includes: providing a SDRAM; sequentially writing a plurality of pixels of a video frame into the SDRAM in a row-by-row scanning manner by a video rotation circuit; dividing a plurality of columns of the video frame into a plurality of column sets, so as to divide each of rows of the video frame into a plurality of sub-rows; and performing an internal column-set scanning for each of the column sets in a column-set-by-column-set manner by the video rotation circuit, so as to discretely read the sub-rows from the SDRAM.

An embodiment of the invention provides a video frame rotation apparatus. The video frame rotation apparatus includes a SDRAM and a video rotation circuit. The video rotation circuit is coupled to the SDRAM. The video rotation circuit divides a plurality of rows of a video frame into a plurality of row sets, so as to divide each of columns of the video frame into a plurality of sub-columns. The video rotation circuit performs an internal row-set scanning for each of the row sets in a row-set-by-row-set manner, so as to discretely write the sub-columns of the video frame into the SDRAM. The video rotation circuit sequentially reads a plurality of pixels of the video frame from the SDRAM in a column-by-column scanning manner.

An embodiment of the invention provides a method for video frame rotation. The method for video frame rotation includes: providing a SDRAM; dividing a plurality of rows of a video frame into a plurality of row sets, so as to divide each of columns of the video frame into a plurality of sub-columns; performing an internal row-set scanning for each of the row sets in a row-set-by-row-set manner by a video rotation circuit, so as to discretely write the sub-columns of the video frame into the SDRAM; and sequentially reading a plurality of pixels of the video frame from the SDRAM in a column-by-column scanning manner.

According to the above description, in some embodiment, the video rotation circuit sequentially writes a plurality of pixels of the video frame into the SDRAM in the row-by-row scanning manner, and discretely reads a plurality of the sub-rows from the SDRAM in the column-set-by-column-set manner, so as to decrease the latency penalty of the SDRAM. In some embodiments, the video rotation circuit discretely writes a plurality of sub-columns of the video frame into the SDRAM in the row-set-by-row-set manner, and sequentially reads a plurality of pixels of the video frame from the SDRAM in the column-by-column scanning manner, so as to decrease the latency penalty of the SDRAM.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of data burst transmission of a synchronous dynamic random access memory (SDRAM).

FIG. 2 is a schematic diagram of video frame rotation.

FIG. 3 is a schematic diagram of data burst transmission of the SDRAM when video frame rotation is performed.

FIG. 4 is a circuit block schematic diagram of a video frame rotation apparatus according to an embodiment of the invention.

FIG. 5 is a flowchart illustrating a method for video frame rotation according to an embodiment of the invention.

FIG. 6 is a schematic diagram of sequentially writing a video frame into the SDRAM according to an embodiment of the invention.

FIG. 7 is a schematic diagram of a data burst transmission when a video rotation circuit sequentially writes a video frame into the SDRAM according to an embodiment of the invention.

FIG. 8 is a schematic diagram of discretely reading a video frame from the SDRAM according to an embodiment of the invention.

FIG. 9 is a schematic diagram of a data burst transmission when the video rotation circuit discretely reads a plurality of sub-rows from the SDRAM according to an embodiment of the invention.

FIG. 10 is a circuit block schematic diagram of the video rotation circuit of FIG. 4 according to an embodiment of the invention.

FIG. 11 is a schematic diagram of reading a column set from a column set temporary storage circuit according to an embodiment of the invention.

FIG. 12 is a flowchart illustrating a method for video frame rotation according to another embodiment of the invention.

FIG. 13 is a schematic diagram of discretely writing a plurality of sub-columns of a video frame into the SDRAM according to an embodiment of the invention.

FIG. 14 is a schematic diagram of a data burst transmission when the video rotation circuit discretely writes a plurality of sub-columns of a video frame into the SDRAM according to an embodiment of the invention.

FIG. 15 is a schematic diagram of sequentially reading a video frame from the SDRAM according to an embodiment of the invention.

FIG. 16 is a schematic diagram of a data burst transmission when the video rotation circuit sequentially reads pixels of a video frame from the SDRAM according to an embodiment of the invention.

FIG. 17 is a circuit block schematic diagram of the video rotation circuit of FIG. 4 according to another embodiment of the invention.

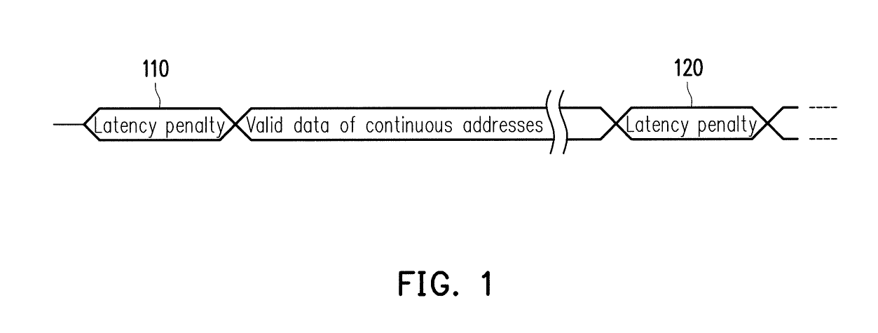

### DESCRIPTION OF EMBODIMENTS

A term “couple” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. Moreover, wherever possible, components/members/steps using the same referential numbers in the drawings and description refer to the same or like parts. Components/members/steps using the same referential numbers or using the same terms in different embodiments may cross-refer related descriptions.

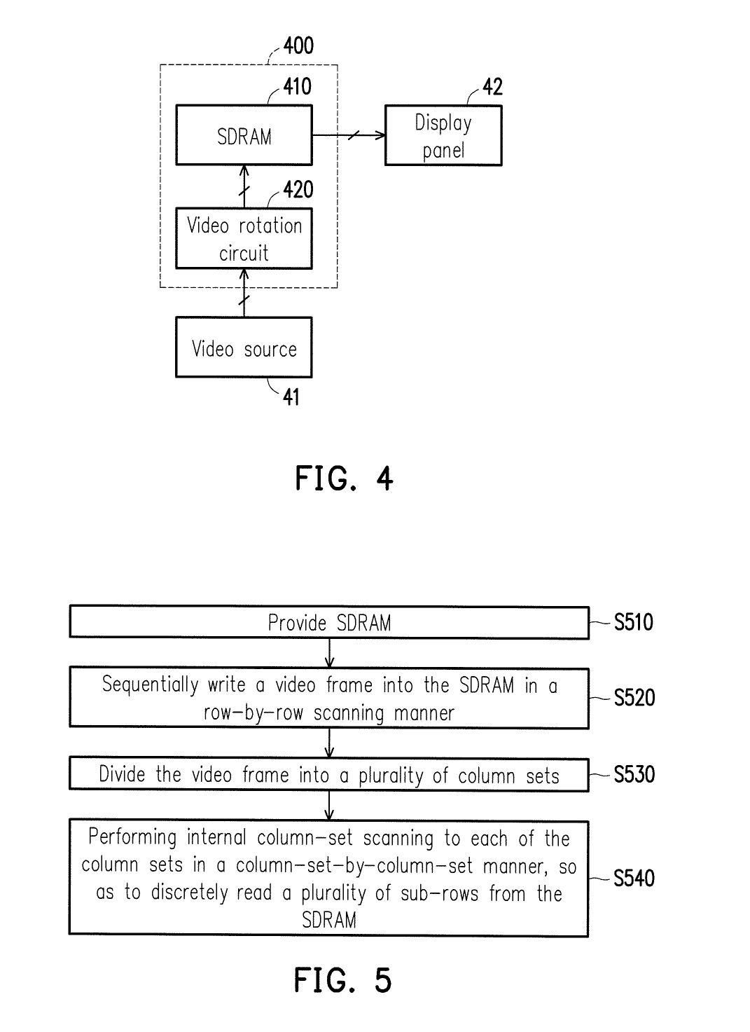

FIG. 4 is a circuit block schematic diagram of a video frame rotation apparatus 400 according to an embodiment of the invention. The video frame rotation apparatus 400 of FIG. 4 includes a synchronous dynamic random access memory (SDRAM) 410 and a video rotation circuit 420. The video rotation circuit 420 is coupled to the SDRAM 410. The video rotation circuit 420 receives a video frame provided by a video source 41. The video rotation circuit 420 may write a plurality of pixels (pixel data) of the video frame into the SDRAM 410, and read a rotated video frame from the SDRAM 410 to the display panel 42. According to a design requirement, the display panel 42 can be a portrait mode display panel or other types of display panel.

FIG. 5 is a flowchart illustrating a method for video frame rotation according to an embodiment of the invention. Referring to FIG. 4 and FIG. 5, in a step S510, the SDRAM 410 is provided to the video frame rotation apparatus 400. The SDRAM 410 is the conventional technique, and detail thereof is not repeated. In step S520, the video rotation circuit 420 sequentially writes a plurality of pixels (pixel data) of a video frame provided by the video source 41 into the SDRAM 410 in a row-by-row scanning manner.

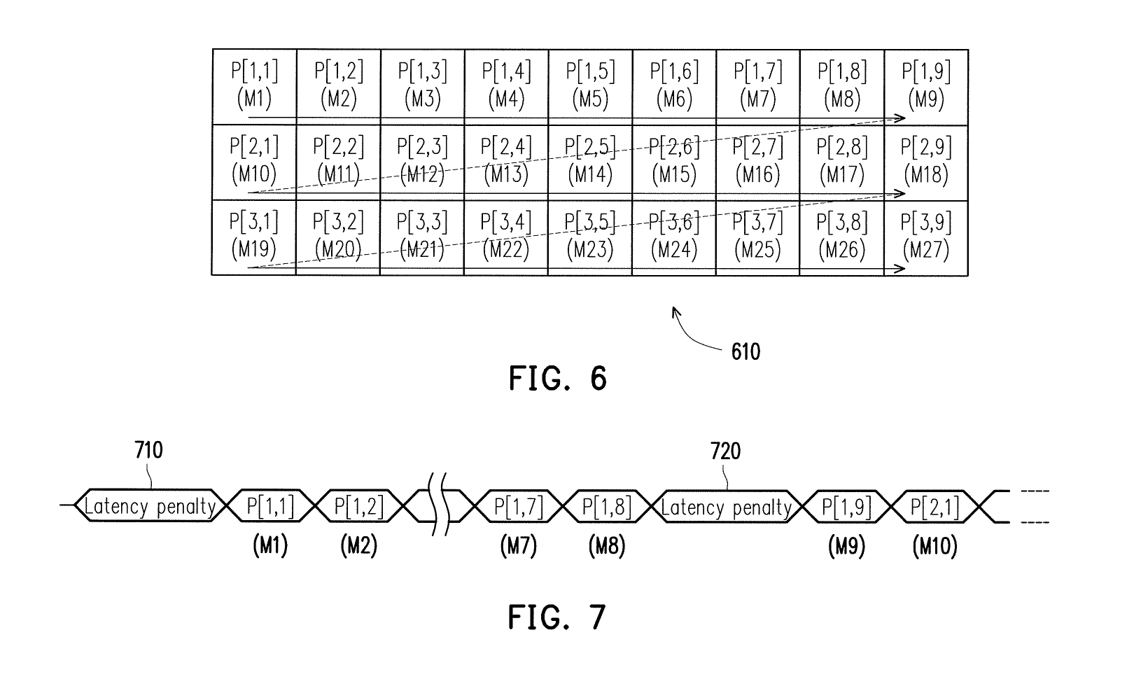

FIG. 6 is a schematic diagram of sequentially writing a video frame 610 into the SDRAM 410 according to an embodiment of the invention. Referring to FIG. 6, the video frame 610 includes pixels P[1,1]-P[1,9], pixels P[2,1]-P[2,9] and pixels P[3,1]-P[3,9], where P[2,1] represents a pixel (pixel data) located at a second row and a first column in a pixel array, and the other pixels can be deduced with reference of the description of P[2,1]. A size of the pixel array contained in the video frame 610 can be determined according to an actual design requirement, and the pixel array of other sizes can be deduced with reference of related description of the video frame 610, and detail thereof is not repeated. Referring to FIG. 4 to FIG. 6, in step S520, the video rotation circuit 420 sequentially writes a plurality of pixels P[1,1]-P[3,9] (pixel data) of the video frame 610 into the SDRAM 410 in the row-by-row scanning manner. For example, as shown in FIG. 6, the video rotation circuit 420 sequentially writes the first row pixels P[1,1]-P[1,9] of the video frame 610 into the continuous addresses Ml-M9 of the SDRAM 410, and then sequentially writes the second row pixels P[2,1]-P[2,9] of the video frame 610 into the continuous addresses M10-M18 of the SDRAM 410, and then sequentially writes the third row pixels P[3,1]-P[3,9] of the video frame 610 into the continuous addresses M19-M27 of the SDRAM 410. The addresses M1-M27 shown in FIG. 6 represent a plurality of continuous addresses of the SDRAM 410. Any one of the addresses M1-M27 shown in FIG. 6, for example, the address M1 may represent a single address of the SDRAM 410, and may also represent a set of addresses (a plurality of continuous addresses) of the SDRAM 410.

FIG. 7 is a schematic diagram of a data burst transmission when the video rotation circuit 420 sequentially writes the video frame 610 into the SDRAM 410 according to an embodiment of the invention, where a horizontal axis of FIG. 7 represents time. It is assumed that (though the invention is not limited thereto) one data burst of the SDRAM 410 may write 8 pixels into the SDRAM 410. Referring to FIG. 6 and FIG. 7, since the addresses M1-M8 are continuous, the pixels P[1,1]-P[1,8] can be written into the SDRAM 410 in one data burst. Before the pixels P[1,1]-P[1,8] are written into the SDRAM 410, the SDRAM 410 requires to spend a latency penalty 710. After the latency penalty 710 is ended, the pixels P[1,1]-P[1,8] can be respectively written into the addresses M1-M8 of the SDRAM 410. Before the pixels P[1,9], P[2,1]-P[2,7] are written into the SDRAM 410, the SDRAM 410 requires to again spend a latency penalty 720. After the latency penalty 720 is ended, the pixels P[1,9], P[2,1]-P[2,7] can be respectively written into the addresses M9-M16 of the SDRAM 410, and transmission of the other pixels can be deduced by analogy.

Referring to FIG. 4 and FIG. 5, in step S530, the video rotation circuit 420 divides the video frame 610 into a plurality of column sets, so as to divide each of rows of the video frame 610 into a plurality of sub-rows. In step S540, the video rotation circuit 420 performs an internal column-set scanning for each of the column sets in a column-set-by-column-set manner, so as to discretely read the sub-rows from the SDRAM 410.

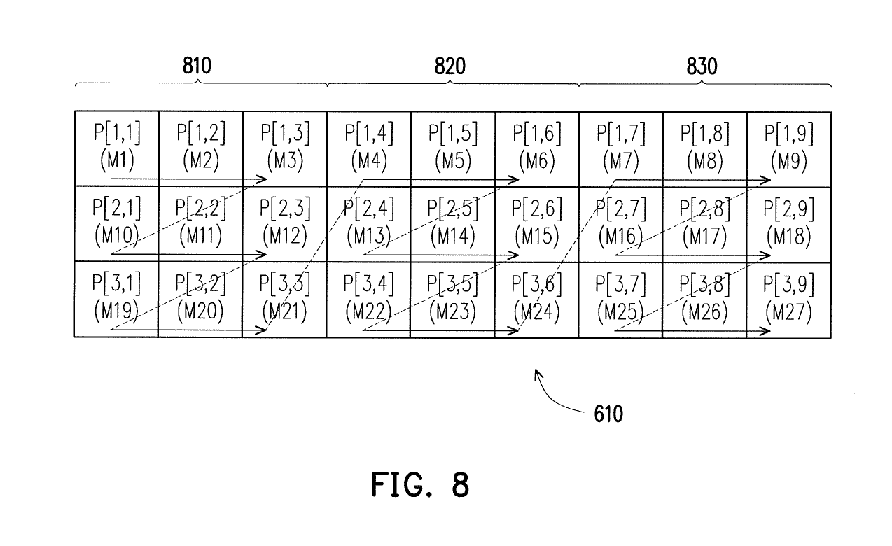

FIG. 8 is a schematic diagram of discretely reading the video frame 610 from the SDRAM 410 according to an embodiment of the invention. The video frame 610 of FIG. 8 may refer to related description of FIG. 6, and detail thereof is not repeated. Referring to FIG. 4 and FIG. 8, the video rotation circuit 420 may divide the columns of the video frame 610 into a plurality of column sets 810, 820 and 830, so as to divide each of rows of the video frame 610 into a plurality of sub-rows. For example, the first row of the video frame 610 is divided into three sub-rows, where the first sub-row includes the pixels P[1,1]-P[1,3], the second sub-row includes the pixels P[1,4]-P[1,6], and the third sub-row includes the pixels P[1,7]-P[1,9]. The number of column sets (or a length of the sub-row, or the number of the pixels of the sub-row) can be determined according to an actual design requirement. For example, the length of the sub-row (or the number of the pixels of the sub-row) can be correlated with the mode of the data burst of the SDRAM 410. The number of the pixels of one sub-row has to be greater than or equal to two pixels. The video rotation circuit 420 may first perform the “internal column-set scanning” to the first column set 810, and perform the “internal column-set scanning” to the second column set 820, and then perform the “internal column-set scanning” to the third column set 830, so as to discretely read the sub-rows from the SDRAM 410.

The so-called “internal column-set scanning” refers to that in one corresponding column set, the pixels of all of the sub-rows of the corresponding column set are read from the SDRAM 410 in a sub-row-by-sub-row scanning manner. Taking the first column set 810 as an example, the video rotation circuit 420 reads the pixels

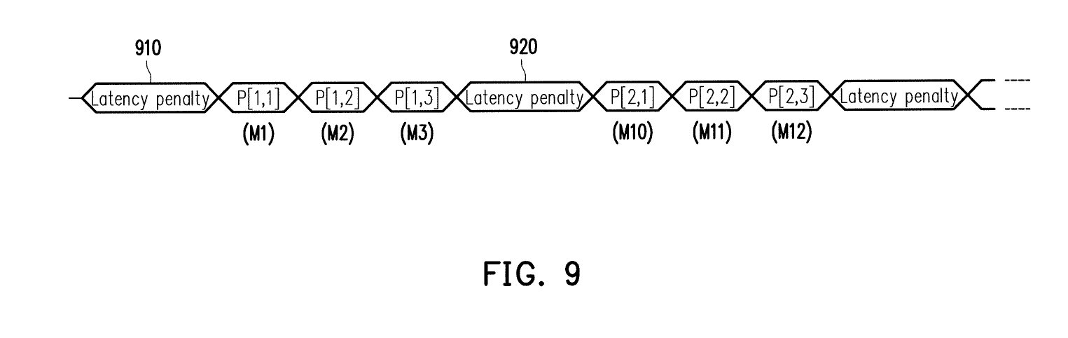

P[1,1]-P[1,3] of the first sub-row of the first column set 810 from the SDRAM 410, and then reads the pixels P[2,1]-P[2,3] of the second sub-row of the first column set 810, and then reads the pixels P[3,1]-P[3,3] of the third sub-row of the first column set 810. FIG. 9 is a schematic diagram of a data burst transmission when the video rotation circuit 420 discretely reads a plurality of the sub-rows from the SDRAM 410 according to an embodiment of the invention, where a horizontal axis of FIG. 9 represents time. Referring to FIG. 8 to FIG. 9, before the pixels P[1,1]-P[1,3] of the first sub-row of the first column set 810 are read from the SDRAM 410, the SDRAM 410 requires to spend a latency penalty 910. After the latency penalty 910 is ended, the pixels P[1,1]-P[1,3] are respectively read from the addresses M1-M3 of the SDRAM 410. Before the pixels P[2,1]-P[2,3] of the second sub-row of the first column set 810 are read from the SDRAM 410, the SDRAM 410 requires to again spend a latency penalty 920. After the latency penalty 920 is ended, the pixels P[2,1]-P[2,3] are respectively read from the addresses M10-M12 of the SDRAM 410, and transmission of the other pixels can be deduced by analogy.

The first column set 810 read from the SDRAM 410 can be stored in a column set temporary storage circuit (not shown in FIG. 4, which is described in detail later). The video rotation circuit 420 scans a plurality of columns of the first column set 810 in the column set temporary storage circuit in a column-by-column manner, so as to read all of the pixels (pixel data) of the first column set 810 from the column set temporary storage circuit to the display panel 42. The column set temporary storage circuit can be a static random access memory (SRAM). The SRAM does not have the latency penalty. The video rotation circuit 420 sequentially reads the pixel P[3,1], the pixel P[2,1] and the pixel P[1,1] from the first column of the first column set 810 in the column set temporary storage circuit, so as to output the pixel P[3,1], the pixel P[2,1] and the pixel P[1,1] to the display panel 42. Then, the video rotation circuit 420 sequentially reads the pixel P[3,2], the pixel P[2,2] and the pixel P[1,2] from the second column of the first column set 810 in the column set temporary storage circuit, so as to output the pixel P[3,2], the pixel P[2,2] and the pixel P[1,2] to the display panel 42. Then, the video rotation circuit 420 sequentially reads the pixel P[3,3], the pixel P[2,3] and the pixel P[1,3] from the third column of the first column set 810 in the column set temporary storage circuit, so as to output the pixel P[3,3], the pixel P[2,3] and the pixel P[1,3] to the display panel 42.

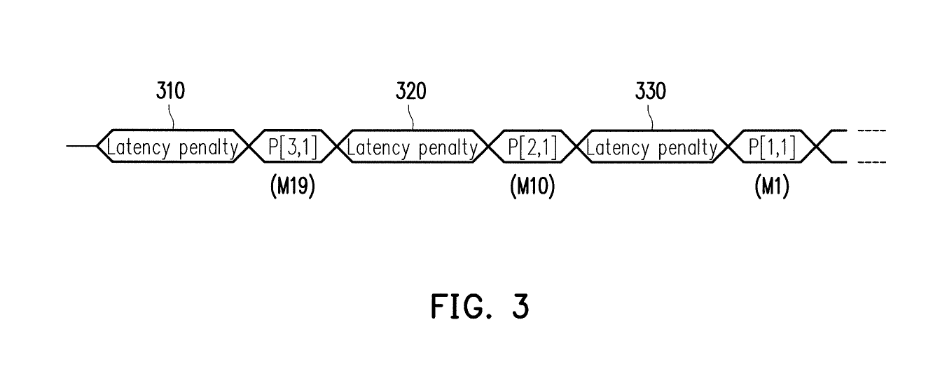

The other column sets 820 and 830 of the video frame 610 can be deduced with reference of related description of the column set 810, and detail thereof is not repeated. Compared to the conventional technique of FIG. 3, the embodiment of FIG. 9 may reduce the latency penalty of the SDRAM 410.

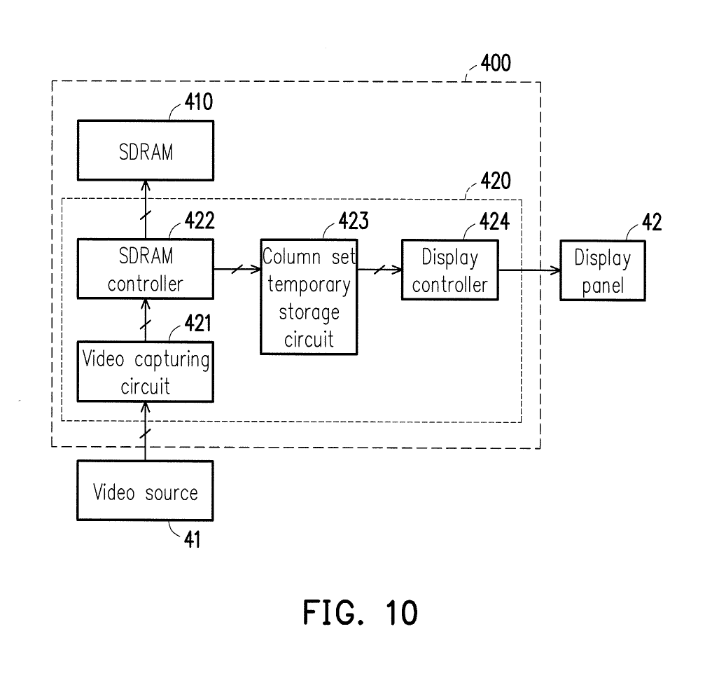

FIG. 10 is a circuit block schematic diagram of the video rotation circuit 420 of FIG. 4 according to an embodiment of the invention. In the embodiment of FIG. 10, the video rotation circuit 420 includes a video capturing circuit 421, a SDRAM controller 422, a column set temporary storage circuit 423 and a display controller 424. The video capturing circuit 421 may capture the video frame 610 from the video source 41, and sequentially outputs a plurality of pixels (pixel data) of the video frame 610 to the SDRAM controller 422 in the row-by-row scanning manner. The implementation that the video capturing circuit 421 outputs the video frame 610 in the row-by-row scanning manner may refer to related description of FIG. 6. The SDRAM controller 422 is coupled to the video capturing circuit 421 and the SDRAM 410. The SDRAM controller 422 may sequentially writes the pixels (pixel data) output by the video capturing circuit 421 into the SDRAM 410. The implementation that the SDRAM controller 422 sequentially writes the pixels output by the video capturing circuit 421 into the SDRAM 410 may refer to related description of FIG. 6.

The column set temporary storage circuit 423 is coupled to the SDRAM controller 422. The video rotation circuit 420 may divide the video frame into a plurality of column sets, as shown in FIG. 8, the video frame 610 is divided into the column set 810, the column set 820 and the column set 830. Regarding one corresponding column set, the SDRAM controller 422 reads the pixels of all of the sub-rows of the corresponding column set from the SDRAM 410 in the sub-row-by-sub-row scanning manner, and stores the pixels of the corresponding column set in the column set temporary storage circuit 423. Taking the video frame 610 of FIG. 8 as an example, the SDRAM controller 422 may first perform the “internal column-set scanning” to the first column set 810, so as to discretely read a plurality of the sub-rows in the column set 810 from the SDRAM 410, and store the column set 810 in the column set temporary storage circuit 423. Then, the SDRAM controller 422 may perform the “internal column-set scanning” to the second column set 820, so as to discretely read a plurality of the sub-rows in the column set 820 from the SDRAM 410, and store the column set 820 in the column set temporary storage circuit 423. Then, the SDRAM controller 422 may perform the “internal column-set scanning” to the third column set 830, so as to discretely read a plurality of the sub-rows in the column set 830 from the SDRAM 410, and store the column set 830 in the column set temporary storage circuit 423.

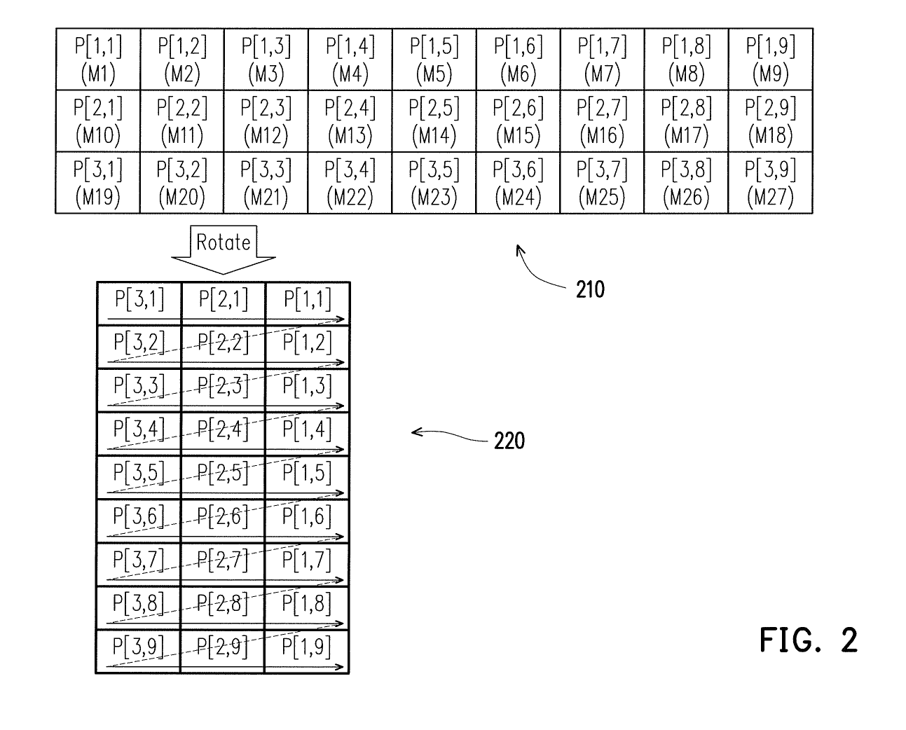

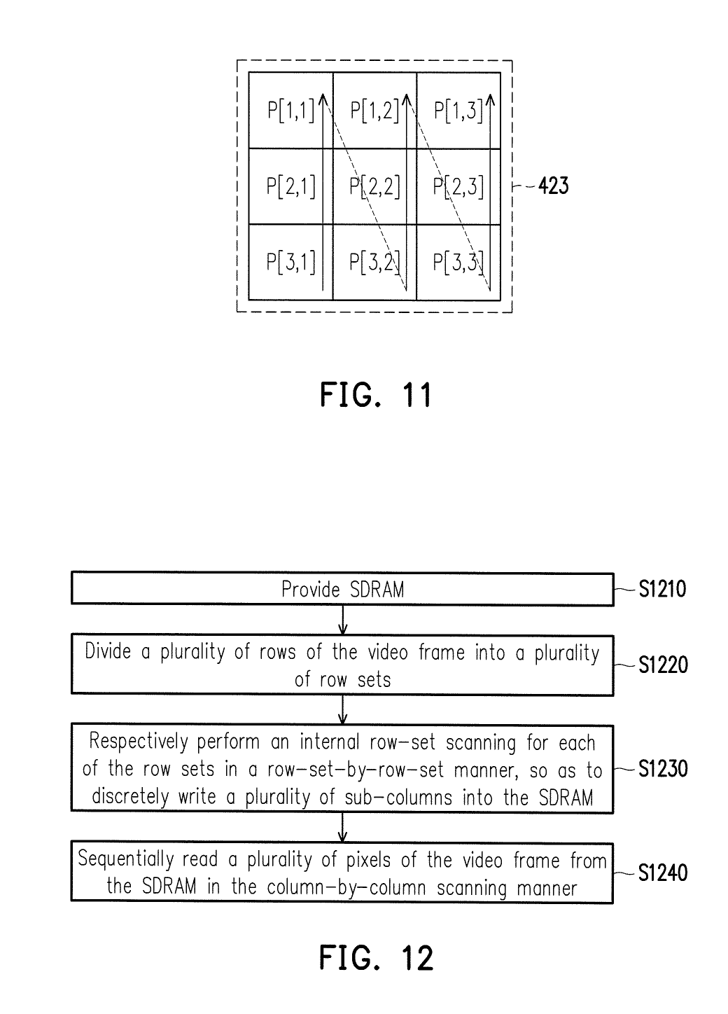

It is assumed that the column set 810 shown in FIG. 8 has been stored in the column set temporary storage circuit 423. FIG. 11 is a schematic diagram of reading a column set 810 from the column set temporary storage circuit 423 according to an embodiment of the invention. When other column sets of the video frame 610 are stored in the column set temporary storage circuit 423, the operations of the display controller 424 can be deduced according to the related description of the column set 810 of FIG. 11. Referring to FIG. 10 and FIG. 11, the display controller 424 is coupled to the column set temporary storage circuit 423. The display controller 424 respectively scans a plurality of columns of the column set 810 stored in the column set temporary storage circuit 423 in a column-by-column manner, so as to read the pixels of the column set 810 from the column set temporary storage circuit 423 to the display panel 42. For example, the display controller 424 sequentially reads the pixels P[3,1], P[2,1], P[1,1] of the first column from the column set temporary storage circuit 423, and sequentially reads the pixels P[3,2], P[2,2], P[1,2] of the second column, and then sequentially reads the pixels P[3,3], P[2,3], P[1,3] of the third column, as shown in FIG. 11. Based on such reading sequence, the display controller 424 may sequentially output the pixels (pixel data) of the column set 810 to the display panel 42. The display panel 42 can be deduced with reference of related description of the portrait mode display panel 220 of FIG. 2. Therefore, a landscape mode video frame 610 can be rotated and displayed on the portrait mode display panel 42.

FIG. 12 is a flowchart illustrating a method for video frame rotation according to another embodiment of the invention. Referring to FIG. 4 and FIG. 12, in step S1210, the SDRAM 410 is provided to the video frame rotation apparatus 400. In step S1220, the video rotation circuit 420 divides a plurality of rows of a video frame into a plurality of row sets, so as to divide each of columns of the video frame into a plurality of sub-columns.

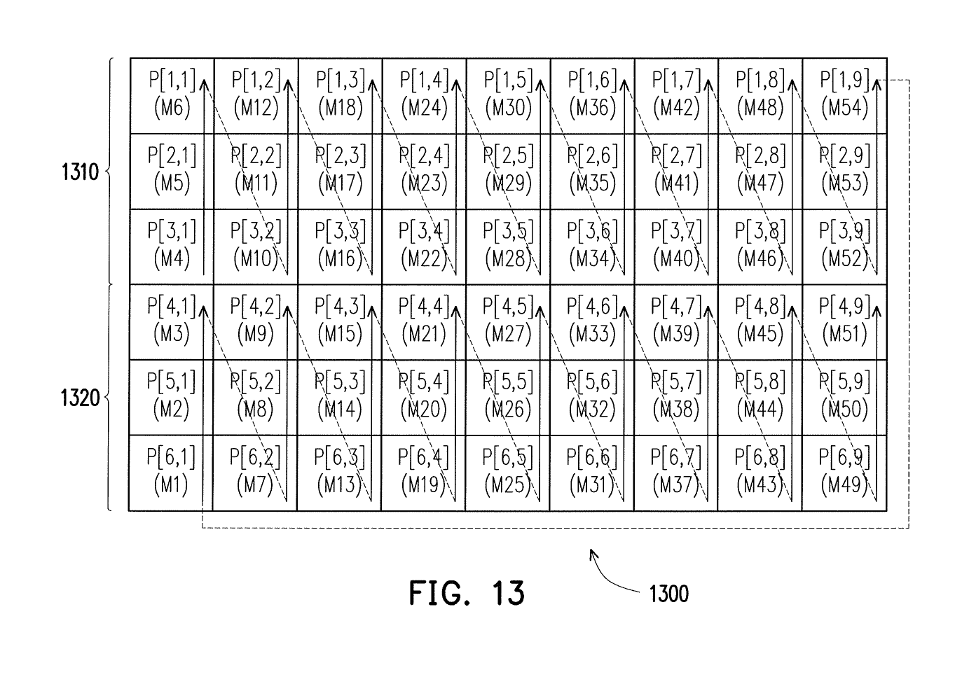

FIG. 13 is a schematic diagram of discretely writing a plurality of sub-columns of a video frame 1300 into the SDRAM 410 according to an embodiment of the invention. Referring to FIG. 4, FIG. 12 and FIG. 13, the video rotation circuit 420 may divide a plurality of rows of a video frame 1300 into a plurality of row sets 1310 and 1320, so as to divide each of columns of the video frame 1300 into a plurality of sub-columns. For example, the first column of the video frame 1300 is divided into two sub-columns, where the first sub-column includes the pixels P[1,1], P[2,1] and P[3,1], and the second sub-column includes the pixels P[4,1], P[5,1] and P[6,1]. The number of the row sets (or a length of the sub-column, or the number of pixels of the sub-column) can be determined according to an actual design requirement. For example, the length of the sub-column (or the number of the pixels of the sub-column) can be correlated with the mode of the data burst of the SDRAM 410. The number of the pixels of one sub-column has to be greater than or equal to two pixels. The video rotation circuit 420 may store one corresponding row set of the row sets 1310 and 1320 of the video frame 1300 into a row set temporary storage circuit (which is not shown in FIG. 4, and is described later).

In step S1230, the video rotation circuit 420 respectively performs an “internal row-set scanning” for each of the row sets 1310 and 1320 in a row-set-by-row-set manner, so as to discretely write the sub-columns of the video frame 1300 into the SDRAM 410. The “internal row-set scanning” refers to that in one corresponding row set, a plurality of pixels (pixel data) of all of the sub-columns of the corresponding column set are read from the row set temporary storage circuit (which is not shown in FIG. 4) in a sub-column-by-sub-column scanning manner, so as to discretely write the sub-columns of the corresponding row set into the SDRAM 410. Taking the first row set 1310 as an example, the video rotation circuit 420 may store the first row set 1310 of the video frame 1300 into the row set temporary storage circuit (which is not shown in FIG. 4). The video rotation circuit 420 reads a plurality of pixels of all of the sub-columns of the first row set 1310 from the row set temporary storage circuit (which is not shown in FIG. 4) in the sub-column-by-sub-column scanning manner, and discretely writes the sub-columns of the first row set 1310 into the SDRAM 410. For example, the video rotation circuit 420 sequentially reads the pixels P[3,1], P[2,1] and P[1,1] of the first sub-column from the row set temporary storage circuit (which is not shown in FIG. 4), and respectively writes the pixels P[3,1], P[2,1] and P[1,1] into the continuous addresses M4-M6 of the SDRAM 410. Then, the video rotation circuit 420 sequentially reads the pixels P[3,2], P[2,2] and P[1,2] of the second sub-column from the row set temporary storage circuit (which is not shown in FIG. 4), and respectively writes the pixels P[3,2], P[2,2] and P[1,2] into the continuous addresses M10-M12 of the SDRAM 410. Then, the video rotation circuit 420 sequentially reads the pixels P[3,3], P[2,3] and P[1,3] of the third sub-column from the row set temporary storage circuit (which is not shown in FIG. 4), and respectively writes the pixels P[3,3], P[2,3] and P[1,3] into the continuous addresses M16-M18 of the SDRAM 410. Deduce by analogy, the other sub-columns shown in FIG. 13 are respectively written into other positions of the SDRAM 410, as shown in FIG. 13. According to such writing sequence, the video rotation circuit 420 discretely writes all of the sub-columns of the video frame 1300 into the SDRAM 410. The addresses M1-M54 shown in FIG. 13 represent a plurality of continuous addresses of the SDRAM 410. Any one of the addresses M1-M54 shown in FIG. 13, for example, the address M1 may represent a single address of the SDRAM 410, and may also represent a set of addresses (a plurality of continuous addresses) of the SDRAM 410.

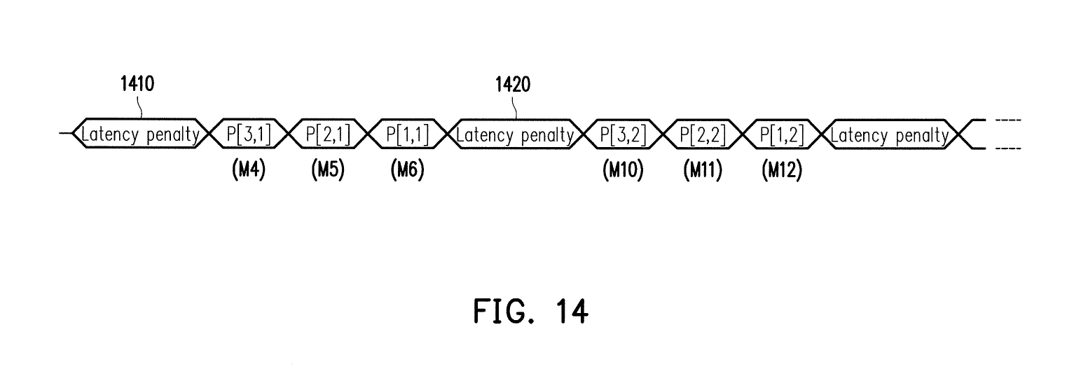

FIG. 14 is a schematic diagram of a data burst transmission when the video rotation circuit 420 discretely writes a plurality of sub-columns of the video frame 1300 into the SDRAM 410 according to an embodiment of the invention, where a horizontal axis of FIG. 14 represents time. Referring to FIG. 13 to FIG. 14, the pixels P[3,1], P[2,1], P[1,1] (pixel data) can be written into the continuous addresses M4-M6 of the SDRAM 410 in one data burst. Before the pixels P[3,1], P[2,1], P[1,1] are written into the SDRAM 410, the SDRAM 410 requires to spend a latency penalty 1410. After the latency penalty 1410 is ended, the pixels P[3,1], P[2,1], P[1,1] are respectively written into the addresses M4-M6 of the SDRAM 410. Before the pixels P[3,2], P[2,2], P[1,2] are written into the SDRAM 410, the SDRAM 410 requires to again spend a latency penalty 1420. After the latency penalty 1420 is ended, the pixels P[3,2], P[2,2], P[1,2] are respectively written into the addresses M10-M12 of the SDRAM 410 , and transmission of the other pixels can be deduced by analogy.

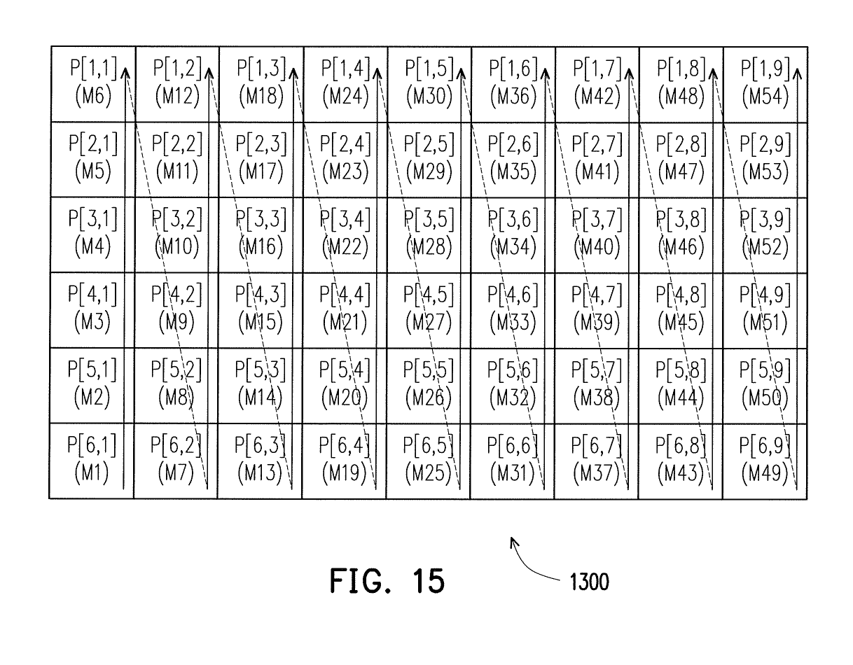

Referring to FIG. 4 and FIG. 12, in step S1240, the video rotation circuit 420 sequentially reads a plurality of pixels (pixel data) of the video frame 1300 from the SDRAM 410 in the column-by-column scanning manner, so as to output the video frame 1300 to the display panel 42. FIG. 15 is a schematic diagram of sequentially reading the video frame 1300 from the SDRAM 410 according to an embodiment of the invention. The video frame 1300 of FIG. 15 may refer to related description of FIG. 13, and detail thereof is not repeated. Referring to FIG. 4 and FIG. 15, the video rotation circuit 420 sequentially reads a plurality of pixels (pixel data) of the video frame 1300 from the SDRAM 410 in the column-by-column scanning manner, so as to output the video frame 1300 to the display panel 42. For example, the video rotation circuit 420 sequentially reads the pixels P[6,1], P[5,1], P[4,1], P[3,1], P[2,1] and P[1,1] of the first column from the SDRAM 410, and sequentially outputs the pixels P[6,1], P[5,1], P[4,1], P[3,1], P[2,1] and P[1,1] to the display panel 42. Then, the video rotation circuit 420 sequentially reads the pixels P[6,2], P[5,2], P[4,2], P[3,2], P[2,2] and P[1,2] of the second column from the SDRAM 410, and sequentially outputs the pixels P[6,2], P[5,2], P[4,2], P[3,2], P[2,2] and P[1,2] to the display panel 42. Then, the video rotation circuit 420 sequentially reads the pixels P[6,3], P[5,3], P[4,3], P[3,3], P[2,3] and P[1,3] of the third column from the SDRAM 410, and sequentially outputs the pixels P[6,3], P[5,3], P[4,3], P[3,3], P[2,3] and P[1,3] to the display panel 42. Deduced by analogy, the video rotation circuit 420 sequentially reads the other pixels (pixel data) of the video frame 1300 from the SDRAM 410 in the column-by-column scanning manner (shown in FIG. 15), so as to output the video frame 1300 to the display panel 42. According to such reading sequence, the video rotation circuit 420 may sequentially output the pixels of the video frame 1300 to the display panel 42 in the column-by-column scanning manner. The display panel 42 can be deduced with reference of related description of the portrait mode display panel 220 of FIG. 2. Therefore, the landscape mode video frame 1300 can be rotated and displayed on the portrait mode display panel 42.

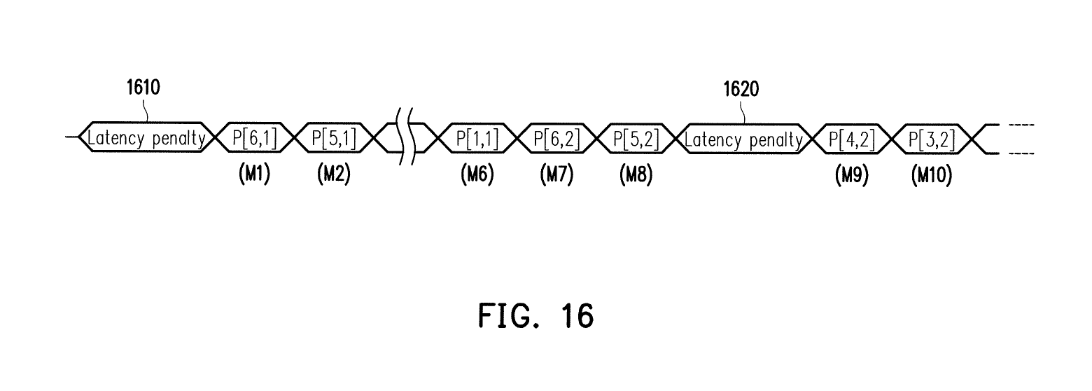

FIG. 16 is a schematic diagram of a data burst transmission when the video rotation circuit 420 sequentially reads the pixels (pixel data) of the video frame 1300 from the SDRAM 410 according to an embodiment of the invention, where a horizontal axis of FIG. 16 represents time. It is assumed that (the invention is not limited thereto) one data burst of the SDRAM 410 may sequentially read 8 pixels from the SDRAM 410. Referring to FIG. 15 to FIG. 16, before the pixels P[6,1], P[5,1], P[4,1], P[3,1], P[2,1], P[1,1], P[6,2] and P[5,2] are sequentially read from the SDRAM 410, the SDRAM 410 requires to spend a latency penalty 1610. After the latency penalty 1610 is ended, the pixels P[6,1], P[5,1], P[4,1], P[3,1], P[2,1], P[1,1], P[6,2] and P[5,2] can be respectively read from the addresses M1 -M8 of the SDRAM 410, and sequentially output to the display panel 42. Before the pixels P[4,2], P[3,2], P[2,2], P[1,2], P[6,3], P[5,3], P[4,3] and P[3,3] are sequentially read from the SDRAM 410, the SDRAM 410 requires to again spend a latency penalty 1620. After the latency penalty 1620 is ended, the pixels P[4,2], P[3,2], P[2,2], P[1,2], P[6,3], P[5,3], P[4,3] and P[3,3] can be respectively read from the addresses M9-M16 of the SDRAM 410. Transmission of the other pixels (pixel data) can be deduced by analogy.

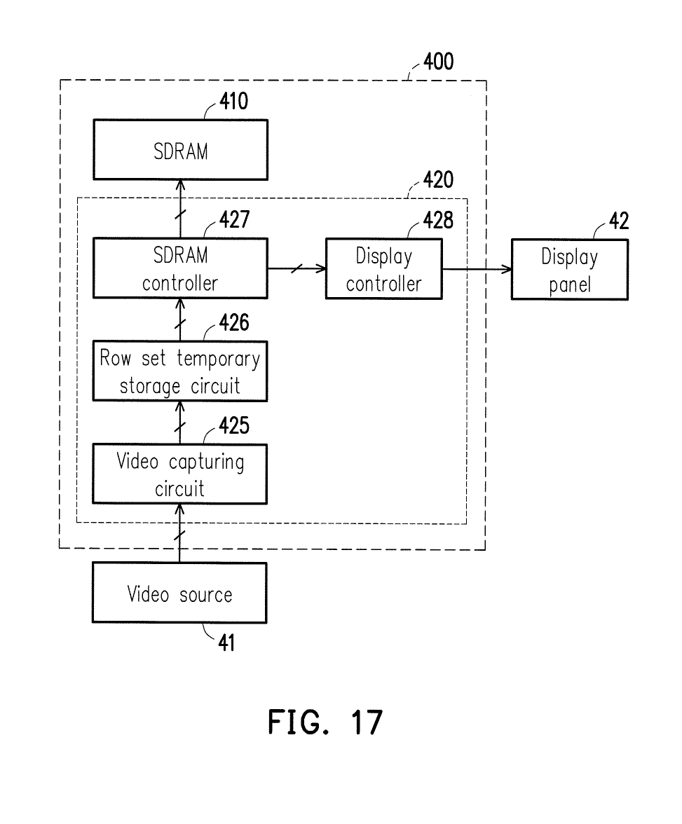

FIG. 17 is a circuit block schematic diagram of the video rotation circuit 420 of FIG. 4 according to another embodiment of the invention. In the embodiment of FIG. 17, the video rotation circuit 420 includes a video capturing circuit 425, a row set temporary storage circuit 426, a SDRAM controller 427 and a display controller 428. The video capturing circuit 425 may capture the video frame 1300 from the video source 41. The video capturing circuit 425 may divide a plurality of rows of the video frame 1300 into a plurality of row sets, and outputs a corresponding row set of the row sets to the row set temporary storage circuit 426. The implementation that the video capturing circuit 425 divides a plurality of rows of the video frame 1300 into a plurality of row sets may refer to related description of FIG. 13. The row set temporary storage circuit 426 is coupled to the video capturing circuit 425 for storing the corresponding row set (for example, the row set 1310 or the row set 1320 of FIG. 13). The SDRAM controller 427 is coupled to the row set temporary storage circuit 426 and the SDRAM 410. The SDRAM controller 427 may discretely write a plurality of sub-columns of the corresponding row set stored in the row set temporary storage circuit 426 into the SDRAM 410. The implementation that the SDRAM controller 427 discretely writes a plurality of sub-columns of the corresponding row set stored in the row set temporary storage circuit 426 into the SDRAM 410 may refer to related description of FIG. 13.

The SDRAM controller 427 may sequentially read all of the pixels in the video frame 1300 from the SDRAM 410 in the column-by-column scanning manner. The implementation that the SDRAM controller 427 sequentially reads all of the pixels in the video frame 1300 from the SDRAM 410 in the column-by-column scanning manner may refer to related description of FIG. 15. The display controller 428 is coupled to the SDRAM controller 427 to receive the pixels, and outputs the pixels to the display panel 42. According to the reading sequence that the SDRAM controller 427 reads the video frame 1300 from the SDRAM 410, the display controller 428 may sequentially output the pixels of the video frame 1300 to the display panel 42. The display panel 42 can be deduced with reference of related description of the portrait mode display panel 220 of FIG. 2. Therefore, the landscape mode video frame 1300 can be rotated and displayed on the portrait mode display panel 42.

It should be noted that in different application situations, related functions of the video rotation circuit 420, the video capturing circuit 421, the SDRAM controller 422, the column set temporary storage circuit 423, the display controller 424, the video capturing circuit 425, the row set temporary storage circuit 426, the SDRAM controller 427 and/or the display controller 428 can be implemented as software, firmware or hardware by using general programming languages (for example, C or C++), hardware description languages (for example, Verilog HDL or VHDL) or other suitable programming languages. The software (or firmware) capable of executing the related functions can be stored in any known computer-accessible medias, for example, magnetic tapes, semiconductor memories, magnetic disks or compact disks (for example, CD-ROM or DVD-ROM), or the software (or firmware) can be transmitted through the Internet, wired communication, wireless communication or other communication media. The software (or firmware) can be stored in computer-accessible media to facilitate a processor of the computer to access/execute programming codes of the software (or firmware). Moreover, the apparatus and method of the invention can be implemented through a combination of hardware and software.

In summary, the in some embodiment, the video frame rotation apparatus 400 and the method for video frame rotation of the invention may rotate the video frame. In some embodiments, the video rotation circuit 420 may sequentially write a plurality of pixels (pixel data) of the video frame into the SDRAM 410 in the row-by-row scanning manner, and discretely read a plurality of the sub-rows from the SDRAM 410 in the column-set-by-column-set manner, so as to decrease the latency penalty of the SDRAM 410. In some other embodiments, the video rotation circuit 420 discretely writes a plurality of sub-columns of the video frame into the SDRAM 410 in the row-set-by-row-set manner, and sequentially reads a plurality of pixels (pixel data) of the video frame from the SDRAM 410 in the column-by-column scanning manner, so as to decrease the latency penalty of the SDRAM 410.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

1. A video frame rotation apparatus, comprising:
a synchronous dynamic random access memory (SDRAM); and
a video rotation circuit, coupled to the SDRAM, and configured to sequentially write a plurality of pixels of a video frame into the SDRAM in a row-by-row scanning manner, wherein the video rotation circuit divides a plurality of columns of the video frame into a plurality of column sets, so as to divide each of rows of the video frame into a plurality of sub-rows, and the video rotation circuit performs an internal column-set scanning for each of the column sets in a column-set-by-column-set manner, so as to discretely read the sub-rows from the SDRAM.

2. The video frame rotation apparatus as claimed in claim 1, wherein the internal column-set scanning refers to that in one corresponding column set of the column sets, the pixels of all of the sub-rows of the corresponding column set are read from the SDRAM in a sub-row-by-sub-row scanning manner.

3. The video frame rotation apparatus as claimed in claim 2, wherein the video rotation circuit stores the corresponding column set coming from the SDRAM into a column set temporary storage circuit, and respectively scans a plurality of columns of the corresponding column set of the video frame in a column-by-column manner, so as to read the pixels of the corresponding column set from the column set temporary storage circuit to a display panel.

4. The video frame rotation apparatus as claimed in claim 3, wherein the display panel is a portrait mode display panel.

5. The video frame rotation apparatus as claimed in claim 1, wherein the video rotation circuit comprises:
a video capturing circuit, configured to capture the video frame from a video source, and sequentially outputting the pixels of the video frame in the row-by-row scanning manner;
a SDRAM controller, coupled to the video capturing circuit and the SDRAM, and configured to sequentially write the pixels output by the video capturing circuit into the SDRAM;
a column set temporary storage circuit, coupled to the SDRAM controller, wherein in a corresponding column set, the SDRAM controller reads the pixels of all of the sub-rows of the corresponding column set from the SDRAM in a sub-row-by-sub-row scanning manner, and stores the pixels of the corresponding column set to the column set temporary storage circuit; and
a display controller, coupled to the column set temporary storage circuit, and configured to respectively scan a plurality of columns of the corresponding column set stored in the column set temporary storage circuit in a column-by-column manner, so as to read the pixels of the corresponding column set from the column set temporary storage circuit to a display panel.

6. A method for video frame rotation, comprising:
providing a synchronous dynamic random access memory (SDRAM);
sequentially writing a plurality of pixels of a video frame into the SDRAM in a row-by-row scanning manner by a video rotation circuit;
dividing a plurality of columns of the video frame into a plurality of column sets, so as to divide each of rows of the video frame into a plurality of sub-rows; and
performing an internal column-set scanning for each of the column sets in a column-set-by-column-set manner by the video rotation circuit, so as to discretely read the sub-rows from the SDRAM.

7. The method for video frame rotation as claimed in claim 6, wherein the internal column-set scanning comprises:
in one corresponding column set of the column sets, reading the pixels of all of the sub-rows of the corresponding column set from the SDRAM in a sub-row-by-sub-row scanning manner.

8. The method for video frame rotation as claimed in claim 7, further comprising:
storing the corresponding column set coming from the SDRAM into a column set temporary storage circuit by the video rotation circuit; and
respectively scanning a plurality of columns of the corresponding column set of the video frame in a column-by-column manner, so as to read the pixels of the corresponding column set from the column set temporary storage circuit to a display panel.

9. The method for video frame rotation as claimed in claim 8, wherein the display panel is a portrait mode display panel.

10. A video frame rotation apparatus, comprising:
a synchronous dynamic random access memory (SDRAM); and
a video rotation circuit, coupled to the SDRAM, and configured to divide a plurality of rows of a video frame into a plurality of row sets, so as to divide each of columns of the video frame into a plurality of sub-columns, wherein the video rotation circuit performs an internal row-set scanning for each of the row sets in a row-set-by-row-set manner, so as to discretely write the sub-columns of the video frame into the SDRAM, and the video rotation circuit sequentially reads a plurality of pixels of the video frame from the SDRAM in a column-by-column scanning manner.

11. The video frame rotation apparatus as claimed in claim 10, wherein the video rotation circuit stores a corresponding row set of the row sets of the video frame to a row set temporary storage circuit, and the internal row-set scanning refers to that in the corresponding row set, the pixels of all of the sub-columns of the corresponding row set are read from the row set temporary storage circuit in a sub-column-by-sub-column scanning manner, so as to discretely write the sub-columns of the corresponding row set into the SDRAM.

12. The video frame rotation apparatus as claimed in claim 10, wherein the video rotation circuit sequentially reads the pixels of the video frame from the SDRAM in the column-by-column scanning manner to a display panel.

13. The video frame rotation apparatus as claimed in claim 12, wherein the display panel is a portrait mode display panel.

14. The video frame rotation apparatus as claimed in claim 10, wherein the video rotation circuit comprises:
a video capturing circuit, configured to capture the video frame from a video source, dividing the rows of the video frame into the row sets, and outputting a corresponding row set of the row sets;
a row set temporary storage circuit, coupled to the video capturing circuit, and storing the corresponding row set;
a SDRAM controller, coupled to the row set temporary storage circuit and the SDRAM, configured to discretely write the sub-columns of the corresponding row set stored in the row set temporary storage circuit into the SDRAM, and sequentially reading the pixels of the video frame from the SDRAM in the column-by-column scanning manner; and
a display controller, coupled to the SDRAM controller to receive the pixels, and configured to output the pixels to a display panel.

15. A method for video frame rotation, comprising:
providing a synchronous dynamic random access memory (SDRAM);
dividing a plurality of rows of a video frame into a plurality of row sets, so as to divide each of columns of the video frame into a plurality of sub-columns;
performing an internal row-set scanning for each of the row sets in a row-set-by-row-set manner by a video rotation circuit, so as to discretely write the sub-columns of the video frame into the SDRAM; and
sequentially reading a plurality of pixels of the video frame from the SDRAM in a column-by-column scanning manner.

16. The method for video frame rotation as claimed in claim 15, wherein the internal row-set scanning comprises:
storing a corresponding row set of the row sets of the video frame into a row set temporary storage circuit; and
reading the pixels of all of the sub-columns of the corresponding row set from the row set temporary storage circuit in a sub-column-by-sub-column scanning manner, so as to discretely write the sub-columns of the corresponding row set into the SDRAM.

17. The method for video frame rotation as claimed in claim 15, wherein the video rotation circuit sequentially reads the pixels of the video frame from the SDRAM in the column-by-column manner to a display panel.

18. The method for video frame rotation as claimed in claim 17, wherein the display panel is a portrait mode display panel.
